(19) United States
(12) Patent Application Publication
(10) Pub. No.: US 2009/0144659 A1
(43) Pub. Date: Jun. 4, 2009

(54) METHOD AND APPARATUS FOR EXECUTING APPLICATIONS IN MOBILE COMMUNICATION TERMINAL

(75) Inventor: Dong-Ho DO, Gwanguj-si (KR)

Correspondence Address: THE FARRELL LAW FIRM, P.C., 290 Broadhollow Road, Suite 210E, Melville, NY, 11747, US

(73) Assignee: SAMSUNG ELECTRONICS CO., LTD., Suwon-si (KR)

(21) Appl. No.: 12/324,275

(22) Filed: Nov. 26, 2008

(30) Foreign Application Priority Data
Nov. 27, 2007 (KR) 10-2007-0121660

(51) Int. Cl. G06F 3/048; G06F 15/16; G06F 9/445

(52) U.S. Cl. 715/825; 709/219; 717/174

(57) ABSTRACT

A method and an apparatus for executing applications in a mobile communication terminal providing portal services are provided. The mobile communication terminal receives a portal package containing at least one portal application and installs it. When there exists a portal application compatible with a pre-mounted terminal application among the applications contained in the portal package, one of both applications is used to display contents associated with both applications.

### PRIORITY

This application claims priority under 35 U.S.C. § 119(a) to an application entitled “Method and Apparatus for Executing Applications in Mobile Communication Terminal” filed in the Korean Intellectual Property Office on Nov. 27, 2007 and assigned Ser. No. 2007-121660, the contents of which are incorporated herein by reference.

### BACKGROUND OF THE INVENTION

1. Field of the Invention

The present invention relates generally to a method and an apparatus for executing applications in a mobile communication terminal, and more particularly, to a method and apparatus for executing applications in a mobile terminal upon reception and installation of a portal application.

2. Description of the Related Art

Portal sites provide basic services including searches and mailing, as well as various enhanced services, such as address services, schedule management, maps, pictures, blogs, cafes, etc. A user with a wired Personal Computer (PC) can receive services through the PC, but, if he/she is traveling or if no PC is available, he/she can browse the web through a mobile communication terminal. While portable services work well on most PCs, their usefulness on mobile communication terminals is degraded. There is an ongoing effort to alleviate such inconveniences using a wired/wireless interworking service, which is one of the iconic features of the current ubiquitous era. However, a considerable number of portal services are still provided having more limitations than wired services.

Wireless-based portal interworking services make it possible to access each portal through a Wireless Internet Numbers for Contents (WINC), or a URL for mobile. Further, with regard to some functions, portals provide virtual machines for download and installation to mobile communication terminals. However, access through a WINC, or a URI for mobile, is useful only when a portal provides categories or functions particularly screen-constructed for wireless mobile environments, and when the portal has more limitations than PC-based services. In addition, portals provide only a small number of virtual machines for each service, making actual use difficult.

### SUMMARY OF THE INVENTION

The present invention has been made to address at least the above problems and/or disadvantages and to provide at least the advantages described below. Accordingly, an aspect of the present invention provides a method and an apparatus for executing applications in a mobile communication terminal that provides portal services.

According to one aspect of the present invention, a method for executing applications in a mobile communication terminal is provided. A portal package containing one or more portal applications is received and installed. It is determined whether there exists a portal application among the one or more portal applications in the portal package that is compatible with a pre-mounted terminal application. One of the compatible portal application and the terminal application is selected as an application for displaying contents associated with the compatible portal application and the terminal application when the compatible portal application exists. The selected application is linked to a corresponding menu item. The associated contents are displayed using the selected application when the corresponding menu item is selected.

According to another aspect of the present invention, a method for executing applications in a mobile communication terminal is provided. A portal server is accessed. A portal package containing at least one portal application is received from the portal server. The received portal package is installed.

According to a further aspect of the present invention, a method for executing applications in a mobile communication terminal is provided. An input is received for selecting a menu item linked to an installed portal application or a terminal application compatible with the installed portal application. A portal server storing contents associated with the installed application or the terminal application compatible with the installed application is accessed. The accessed portal server is requested to provide the associated contents. It is determined whether a login is necessary for a portal service providing the associated contents. It is determined whether the terminal has logged into the portal server when the login is necessary. The associated contents are received and displayed using the installed portal application or the terminal application compatible with the installed portal application when the terminal has logged into the portal server.

According to an additional aspect of the present invention, an apparatus is provided for executing applications in a mobile communication terminal. The apparatus includes a wired/wireless communication unit for receiving a portal package containing one or more portal applications from a portal server, and a virtual machine driving unit for installing the received portal package and executing the one or more portal applications. The apparatus also includes a controller for determining whether there exists a portal application among the one or more portal applications in the portal package compatible with a pre-mounted terminal application. When a compatible portal application exists, one of the compatible portal application and the premounted terminal application is selected as an application for displaying contents associated with both applications. The controller links the selected application to a corresponding menu item. When the menu item is selected, the virtual machine driving unit is controlled so as to drive the selected application linked to the menu item. The apparatus also includes a display unit for displaying the associated contents.

According to another aspect of the present invention, a method for executing applications in a mobile communication terminal is provided. A plurality of portal servers are accessed and a plurality of portal applications contained in different portal packages are received. The received portal applications are installed. The portal applications are linked to corresponding menu items to reconstruct menus. Associated contents are displayed using respective portal applications corresponding to selected menu items linked to the portal applications.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating a communication system including a mobile communication terminal according to an embodiment of the present invention;

FIG. 2 is a block diagram schematically illustrating a construction of a mobile communication terminal according to an embodiment of the present invention;

FIG. 3 is a flowchart illustrating a method for executing applications in a mobile communication terminal according to an embodiment of the present invention;

FIG. 4 is a flowchart illustrating a method for executing applications according to another embodiment of the present invention;

FIG. 5 is a flowchart illustrating a method for executing applications in a mobile communication terminal according to another embodiment of the present invention;

FIG. 6 is a diagram illustrating a portal package installed in a mobile communication terminal according to an embodiment of the present invention;

FIG. 7 is a diagram illustrating a structure of a portal package installed in a mobile communication terminal according to an embodiment of the present invention;

FIG. 8 is a flowchart illustrating a method for installing a portal package in a mobile communication terminal according to an embodiment of the present invention; and

FIG. 9 is a diagram illustrating portal applications installed in a mobile communication terminal according to an embodiment of the present invention.

### DETAILED DESCRIPTION OF THE PREFERRED EMBODIMENT

Preferred embodiments of the present invention are described in detail with reference to the accompanying drawings. It should be noted that similar reference numerals and characters denote corresponding features consistently throughout the attached drawings. Detailed descriptions of constructions or processes known in the art may be omitted to avoid obscuring the subject matter of the present invention.

Hereinafter, a server for providing portal services is referred to as a portal server, and a package including at least one application for providing portal services is referred to as a portal package. Moreover, an application included in the portal package is referred to as a portal application, and an application pre-mounted on a mobile communication terminal is referred to as a terminal application.

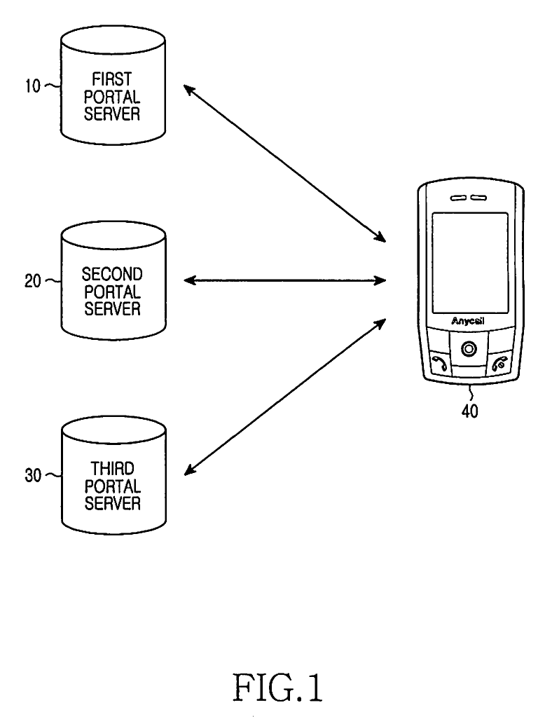

FIG. 1 is a diagram illustrating a communication system including a mobile communication terminal according to an embodiment of the present invention.

A mobile communication terminal 40 accesses at least one of portal servers 10, 20, and 30 to receive certain contents. This embodiment of the present invention illustrates an example having three portal servers.

The mobile communication terminal 40 receives a portal package from one of a first portal server 10, a second portal server 20, and a third portal server 30, and then installs the received portal package. It is assumed that a portal package received from the first portal server 10 corresponds to a first portal package, a portal package received from the second portal server 20 corresponds to a second portal package, and a portal package received from the third portal server 30 corresponds to a third portal package. The mobile communication terminal 40 detects user input for selecting one of the first through third portal packages. Assuming that a portal package selected by the user input corresponds to the second portal package, the mobile communication terminal 40 accesses the second portal server 20 to receive and install the corresponding portal package.

The mobile communication terminal 40, according to an embodiment of the present invention, may install only one of the first through third portal packages. If the first portal package has already been installed in the mobile communication terminal 40, and if the mobile communication terminal 40 detects user input selecting the third portal package, the mobile communication terminal 40 deletes the pre-installed first portal package, receives the third portal package from the third portal server 30, and installs it.

The mobile communication terminal 40 according to another embodiment of the present invention may selectively install only some of the applications contained in the first through third portal packages. For example, it is assumed that the first portal package includes first, second, and third portal applications, that the second portal package includes fourth and fifth portal applications, and that the third portal package includes sixth and seventh portal applications. The mobile communication terminal 40 detects an input for selecting the third, fifth, and seventh portal applications. Then, the mobile communication terminal 40 receives the third portal application from the first portal server 10, the fifth portal application from the second portal server 20, and the seventh portal application from the third portal server 30, respectively, and installs them.

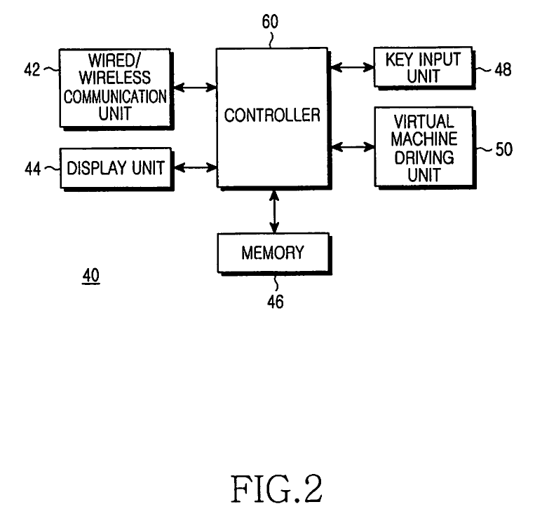

FIG. 2 is a block diagram schematically illustrating a construction of a mobile communication terminal according to an embodiment of the present invention.

The mobile communication terminal 40 includes a wired/wireless communication unit 42, a display unit 44, a memory 46, a key input unit 48, a virtual machine driving unit 50, and a controller 60.

The wired/wireless communication unit 42 performs a wired/wireless communication function of the mobile communication terminal 40. The wired/wireless communication unit 42 includes an RF transmitter (not shown) for upward-converting and amplifying frequencies of transmitted signals. The wired/wireless communication unit 42 also includes an RF receiver (not shown) for low-noise amplifying received signals and downward-converting frequencies.

The wired/wireless communication unit 42, according to an embodiment of the present invention, accesses a portal server and receives a portal package or at least one portal application. Moreover, the wired/wireless communication unit 42 receives contents associated with the portal application from the portal server.

The display unit 44 may include a Liquid Crystal Display (LCD), and outputs various display data created in the mobile communication terminal 40. When an LCD is implemented in a touch screen type, the display unit 44 may serve as an input means. The display unit 44, according to an embodiment of the present invention, displays contents received from the portal server through the wired/wireless communication unit 42.

The memory 46 may include a program memory and a data memory. The memory 46 stores various types of information required for operation control of the mobile communication terminal 40.

The memory 46, according to an embodiment of the present invention, stores a portal package received through the wired/wireless communication unit 42 or at least one portal application included in the portal package. Moreover, the memory 46 stores at least one terminal application that has already been installed in the mobile communication terminal 40. When the wired/wireless communication unit 42 receives contents associated with the portal application, the memory 46 stores the received contents.

The key input unit 48 includes keys for receiving inputs of numbers and characters, as well as keys for setting various functions, and receives inputs from the user.

The key input unit 48, according to an embodiment of the present invention, detects a user input for selecting a portal package. The key input unit 48 may detect a user input for selecting at least one portal application contained in portal packages. Moreover, when a terminal application compatible with the portal application has already been mounted in the mobile communication terminal 40, the key input unit 48 may detect an input for determining whether to display associated contents through the portal application or through the terminal application.

The virtual machine driving unit 50 installs and drives a portal application. When a portal package is received through the wired/wireless communication unit 42, the virtual machine driving unit 50, according to an embodiment of the present invention, installs the received portal package within the mobile communication terminal 40. Further, the virtual machine driving unit 50 drives the portal application so that the display unit 44 can display associated contents using the portal application.

Under the control of the controller 60, described in greater detail below, the virtual machine driving unit 50 may delete the installed portal package or at least one portal application.

The controller 60 controls the overall operation of the mobile communication terminal 40. When a portal package is installed in the mobile communication terminal 40, the controller 60, according to an embodiment of the present invention, determines whether there exists a portal application compatible with the pre-mounted terminal application among at least one installed portal application. When such a portal application exists, the controller 60 selects which of both applications is to be used to display associated contents. The controller 60 may refer to a pre-set value within the mobile communication terminal 40 and determine which of the portal application and the terminal application will be used as an application for displaying associated contents. Further, the controller 60 may detect user input and determine which application will be used to display contents.

Before the portal package received from the portal server is installed, the controller 60 determines whether there exists a pre-installed portal package within the mobile communication terminal 40. When there exists the pre-installed portal package, the controller 60 controls the virtual machine driving unit 50 so that the pre-installed portal package is deleted and the portal package received from the portal server is installed. In contrast, when there exists no pre-installed portal package, the controller 60 controls the virtual machine driving unit 50 so that the received portal package is installed.

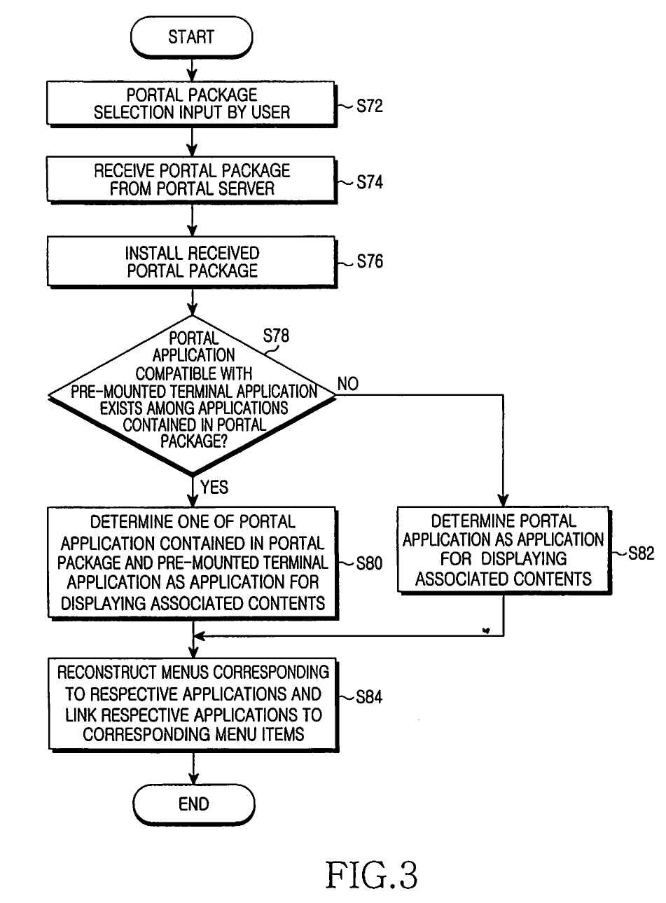

FIG. 3 is a flowchart illustrating a method for executing applications in a mobile communication terminal according to an embodiment of the present invention.

The user inputs a portal package selection through the key input unit 48 of the mobile communication terminal 40 in step S72. The wired/wireless communication unit 42 receives a portal package including at least one portal application in step S74. The key input unit 48 detects a user input for selecting the portal package, and the wired/wireless communication unit 42 receives the portal package selected by the user input from a corresponding portal server.

When the portal package is received from the portal server, the virtual machine driving unit 50 installs the received portal package in step S76. The portal package includes at least one portal application. The virtual machine driving unit 50 may install at least one portal application included in the portal package, and then execute the installed portal application.

The controller 60 determines whether there exists a portal application compatible with a pre-mounted terminal application among the portal applications included in the portal package in step S78.

The confirmation regarding whether or not there exists a portal application compatible with the pre-mounted terminal application may be based on, for example, application information already included in the portal package. The portal package, according to an embodiment of the present invention, may include application information regarding each portal application. The application information may include the type of contents that a corresponding portal application can display, information regarding compatible applications, etc.

When there exists a compatible application (if YES in step S78), the controller 60 determines one of the portal applications included in the portal package and the pre-mounted terminal application as an application for displaying associated contents in step S80.

The selection of the application for displaying associated contents is made by the controller 60. Particularly, the controller 60 may control the display unit 44 and receive a user input regarding which of both applications will be used to display associated contents during the portal application installation process.

For example, the controller 60 controls the display unit 44 to provide a pop-up window reading “This is a portal application compatible with the terminal application. Do you want to display corresponding contents through this portal application?” When the user input corresponds to “YES,” the display unit 44 displays contents using the portal application. In contrast, when the user input corresponds to “NO,” the display unit 44 displays contents using the terminal application.

When certain contents can be displayed through both the portal application and the terminal application, the mobile communication terminal 40, according to another embodiment of the present invention, may be preset to display contents through the terminal application. In this case, the controller 60 selects the terminal application as the application for displaying corresponding contents.

In contrast, when the portal application is preset as the application for displaying contents, the controller 60 selects the portal application as the application for displaying contents.

Referring again to FIG. 3, when there exists no compatible application (if NO in step S78), the controller 60 determines the portal application as the application for displaying associated contents in step S82. Therefore, when the portal application is selected by a user input, the virtual machine driving unit 50 drives the selected portal application so that the display unit 44 can display associated contents.

The controller 60 reconstructs menus corresponding to respective applications, and links respective applications to corresponding menu items in step S84. Since the portal application has been installed, the mobile communication terminal 40 should reconstruct menus corresponding to respective applications. As used herein, reconstruction of menus refers to processes of linking each portal application or terminal application to a corresponding menu item, and displaying menu items that have been newly added or modified through a user interface, such as a menu screen.

The controller 60 processes menu items newly created by portal package installation, as well as pre-stored menu items, during the menu reconstruction process in the following manner. The display unit 44 may display the newly created menu items together with the pre-stored menu items under the control of the controller 60, and the controller 60 may link respective applications to corresponding menu items.

When a menu item is newly created by installation of the portal package, if a terminal application compatible with the portal application has already been mounted, the controller 60 may link one of both applications to a menu item. Further, when a terminal application is compatible with the portal application, the menu item to which the terminal application is linked may be replaced with the menu item created by installation of the portal package.

For example, the pre-stored menu item is displayed, and associated contents are displayed by the portal application. Alternatively, the menu item, which is newly created by portal package installation, is displayed, and associated contents are displayed by the pre-mounted terminal application.

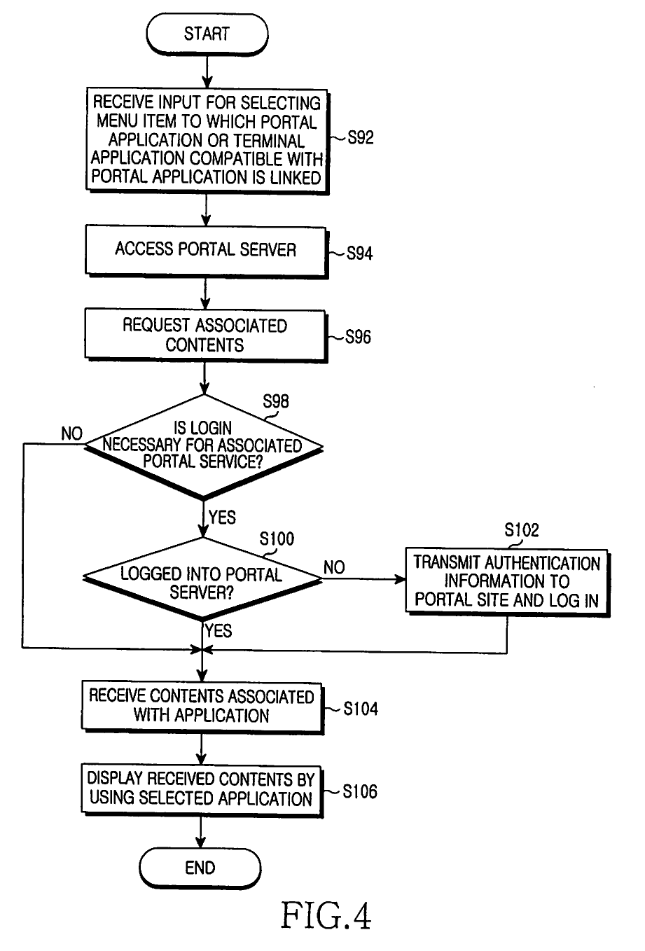

FIG. 4 is a flowchart illustrating a method for executing applications according to another embodiment of the present invention.

When the mobile communication terminal 40 receives an input for selecting a menu item, to which a portal application or a terminal application compatible with the portal application is linked, through the key input unit 48 in step S92, the mobile communication terminal 40 accesses the portal server in step S94. The mobile communication terminal 40 requests the accessed portal server to provide contents associated with the application in step S96.

The controller 60 determines whether a login is necessary for the portal service associated with the contents in step S98. Portal services provided by the portal server include, for example, mail, search engine, phonebook, schedule, blog, cafe, and news services. It is assumed that, among of the above-described services, the mail, phonebook, schedule, blog, and café services require the user's login, and the search engine and news services can be used without the user's login. In order to receive contents regarding the mail, phonebook, schedule, blog, and café services, the mobile communication terminal 40 must complete a login to the portal server. In contrast, the mobile communication terminal 40 can access the portal server and receive contents regarding the search engine and news services without a separate login.

When a portal service does not require a login (if NO in step S98), the mobile communication terminal 40 receives contents associated with the application in step S104. When a portal service requires a login (if YES in step S98), the controller 60 determines whether the mobile communication terminal 40 has logged into the portal server in step S100. When the mobile communication terminal 40 has logged into the portal server (if YES in step S100), the mobile communication terminal 40 receives contents associated with the application in step S104. In contrast, when the mobile communication terminal 40 has not logged into the portal server (if NO in step S100), the mobile communication terminal 40 transmits authentication information to the portal server and logs in step S102. In this case, the authentication information may include, for example, an ID, a password, and a certificate.

When the mobile communication terminal 40 has logged into the portal server, the portal server, according to an embodiment of the present invention, may maintain the login state of the corresponding mobile communication terminal 40 so that it does not need to undergo the same login process for a later access.

After logging into the portal server, the mobile communication terminal 40 receives contents associated with the application through the wired/wireless communication unit 42 in step S104. The mobile communication terminal 40 displays the received contents through the selected application in step S106.

The mobile communication terminal 40, according to an embodiment of the present invention, may display contents received from the portal server and pre-stored contents at the same time. For example, it is assumed that contents received from the portal server correspond to a first phonebook, and a second phonebook has been stored in the mobile communication terminal 40. The controller 60 then controls the mobile communication terminal 40 so that both the first phonebook and the second phonebook can be displayed. In this case, when identical content exists, i.e. the same telephone number, the controller 60 controls the display unit 44 to display the single telephone number.

According to another embodiment of the present invention, the mobile communication terminal 40 may display the first phonebook through a portal application that has been received from the portal server and installed, and display the second phonebook through the pre-mounted terminal application. Menu items linked to respective applications are either those created during portal package installation or those stored in advance.

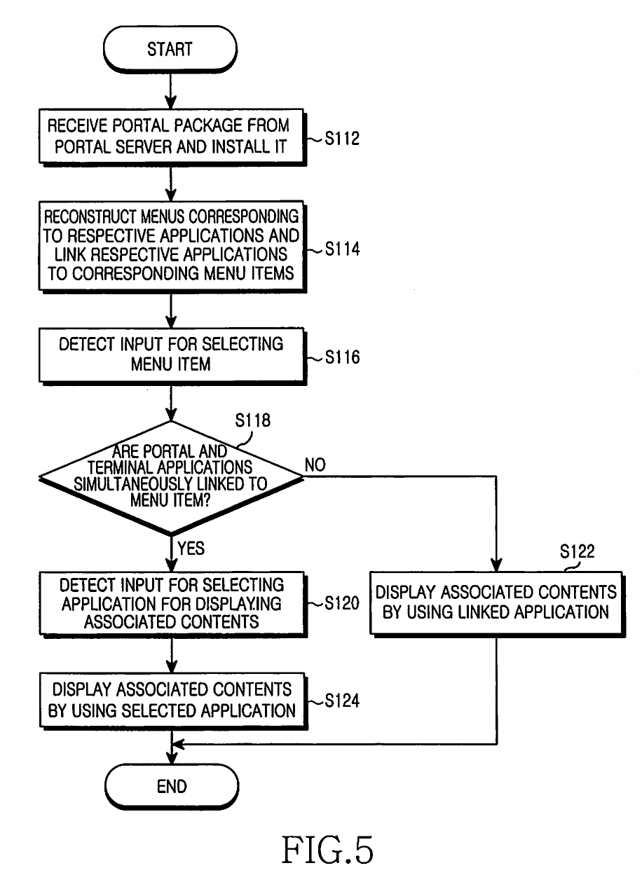

FIG. 5 is a flowchart illustrating a method for executing applications in the mobile communication terminal according to another embodiment of the present invention.

After receiving a portal package from the portal server, the mobile communication terminal 40 installs the received portal package in step S112. The controller 60 reconstructs menus corresponding to respective applications, and links each application to a corresponding menu item in step S114.

Thereafter, the key input unit 48 of the mobile communication terminal 40 detects an input for selecting a specific menu item in step S116. The controller 60 determines whether the selected menu item is linked to both the portal application and the terminal application in step S118. When the selected menu item is linked to both the portal application and the terminal application, contents associated with both the portal application and the terminal application can be displayed. That is, the portal application is compatible with the terminal application. When there exists a terminal application compatible with the portal application during installation of the portal package, determination regarding which application will be given the priority and used to display associated contents can be made by detecting user input in step S120, described in greater detail below.

As such, the controller 60 can control the display unit 44 and the key input unit 48 to provide a pop-up, for example, and receive a selection from the portal and terminal applications. For example, a popup window reading “Select one from 1. portal application and 2. terminal application” is displayed. When an input corresponding to either application is received, the application to be executed is determined accordingly.

If the portal application and the terminal application are simultaneously linked (if YES in step S118), the mobile communication terminal 40 receives a user input for selecting an application for displaying associated contents in step S120. When an application is selected, the mobile communication terminal 40 displays the associated contents using the selected application in step S124.

According to another embodiment of the present invention, the controller 60 solely links the selected application to a corresponding menu item and, if the corresponding menu item is selected later, displays an associated content menu using the linked application. For example, when the user has selected the portal application, the controller 60 stores the selection and controls the mobile communication terminal 40 so that, every time the corresponding menu item is selected, the portal application is used to display associated contents.

If the portal application and the terminal application are not simultaneously linked (if NO step S118), the mobile communication terminal 40 displays associated contents using the linked application in step S122.

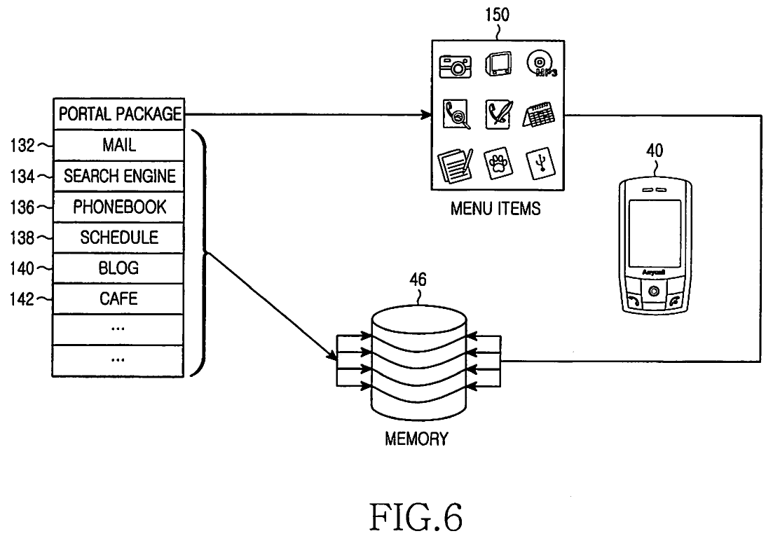

FIG. 6 is a diagram illustrating a portal package installed in a mobile communication terminal according to an embodiment of the present invention.

Referring to FIG. 6, the portal package includes applications regarding mail 132, a search engine 134, a phonebook 136, a schedule 138, a blog 140, a café 142, etc. When the portal package is installed, respective applications are linked to menu items 150.

The applications 132, 134, 136, 138, 140, and 142 and the menu items linked to respective applications 132, 134, 136, 138, 140, and 142 are stored in the memory 46 of the mobile communication terminal 40. The display unit 44 displays the menu items, and the key input unit 48 detects a selection input for selecting one from the displayed menu items. The controller 60 refers to the memory 46 to identify the application and contents corresponding to the selected menu item. When the corresponding application is a portal application, the controller 60 controls the virtual machine driving unit 50 so that the corresponding portal application is driven.

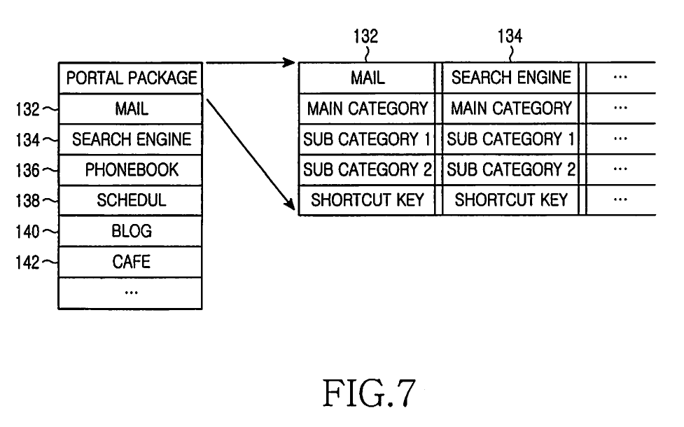

FIG. 7 is a diagram illustrating a structure of a portal package installed in the mobile communication terminal according to an embodiment of the present invention.

The portal package includes portal applications regarding mail 132, a search engine 134, a phonebook 136, a schedule 138, a blog 140, a café 142, etc. Each portal application may include a main category, a sub category 1, a sub category 2, and a shortcut key. The shortcut key may be stored in the memory 46 while the portal package is installed in the mobile communication terminal 40.

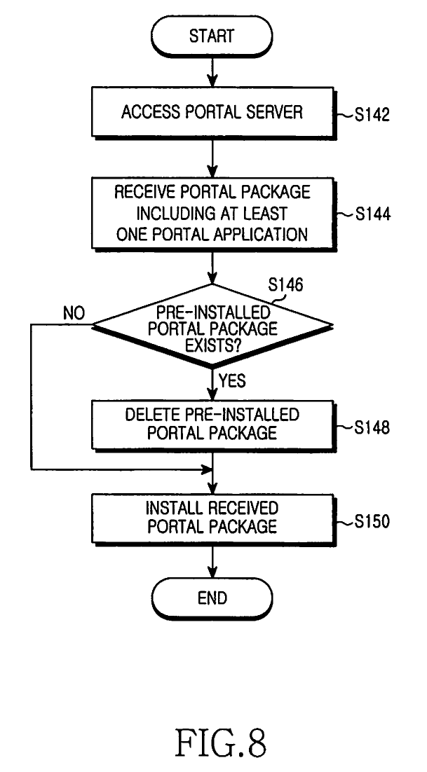

FIG. 8 is a flowchart illustrating a method for installing a portal package in the mobile communication terminal according to an embodiment of the present invention.

The wired/wireless communication unit 42 of the mobile communication terminal 40 accesses the portal server in step S142. The key input unit 48 may detect a user input for selecting a portal package stored in the portal server.

The wired/wireless communication unit 42 receives a portal package containing at least one portal application in step S144. The controller 60 determines whether there exists a pre-installed portal package in step S146. When there exists a pre-installed portal package (if YES in step S146), the pre-installed portal package is deleted in step S148, and the received portal package is installed in step S150.

When there exists no pre-installed portal package (if NO in step S146), the received portal package is installed in step S150.

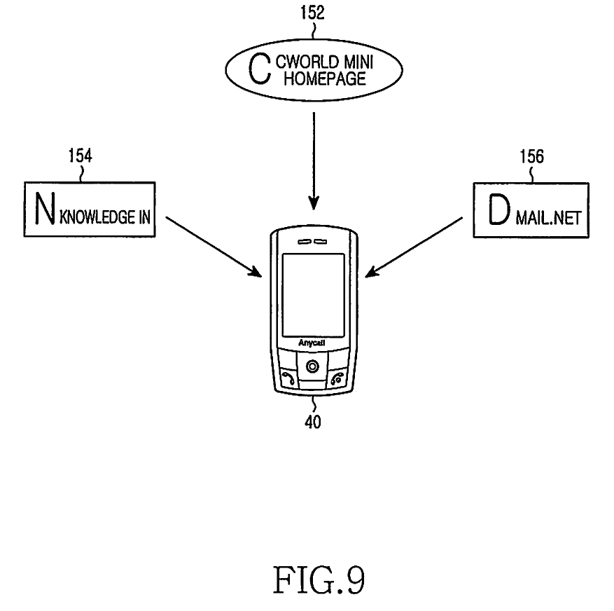

FIG. 9 is a diagram illustrating portal applications installed in a mobile communication terminal according to an embodiment of the present invention.

The mobile communication terminal 40 may receive at least one portal application contained in different portal packages from respective portal servers and install the received portal applications. Referring to FIG. 9, the mobile communication terminal 40 has installed portal applications ‘N knowledge IN’ 154, ‘Cworld Mini Homepage’ 152, and ‘D mail.net’ 156. In this case, the portal application ‘Cworld Mini Homepage’ 152 has been received from portal server ‘C’ and installed; the portal application ‘N knowledge IN’ 154 has been received from portal server ‘N’ and installed; and the portal application of ‘D mail.net’ 156 has been received from portal server ‘D’ and installed. As such, the mobile communication terminal 40 can access a plurality of portal servers and selectively receive and install only a desired portal application.

The present invention provides a method and an apparatus for executing applications in a mobile communication terminal providing portal services.

Further, according to an embodiment of the present invention, it is possible to conveniently use portal services provided by the portal server by installing a portal package.

Furthermore, according to an embodiment of the present invention, it is possible to access a desired portal server so as to receive and install only a desired portal application, thereby implementing a mobile communication terminal capable of selecting only desired functions in respective portal servers and using them.

Also, according to an embodiment of the present invention, it is possible to display associated contents not only through a portal application installed by the portal package, but also through a terminal application compatible with the portal application.

Also, according to an embodiment of the present invention, it is possible to select one from a portal application and a terminal application when they are compatible with each other. Therefore, associated contents can be displayed through either application so that, even in the case of contents received from the portal server, they can be displayed together and provided to the user if they are similar to contents stored in the mobile communication terminal. This improves user convenience.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for executing applications in a mobile communication terminal, the method comprising the steps of:
receiving and installing a portal package including one or more portal applications;
determining whether there exists a portal application among the one or more portal applications in the portal package that is compatible with a pre-mounted terminal application;
selecting, when a compatible portable application exists, one of the compatible portal application and the terminal application as an application for displaying contents associated with the compatible portal application and the terminal application;
linking the selected application to a corresponding menu item; and
displaying the associated contents using the selected application when the corresponding menu item is selected.

2. The method of claim 1, wherein receiving and installing the portal package comprises:
detecting a user input for selecting the portal package;
accessing a portal server storing the portal package to receive the portal package; and
installing the portal package.

3. The method of claim 1, further comprising selecting the terminal application as the application for displaying the associated contents when the compatible portal application does not exist.

4. The method of claim 1, wherein selecting the application for displaying the associated contents comprises:
detecting a user input for selecting one of the compatible portal application and the terminal application; and
define the application selected by the user input as the application for displaying the associated contents.

5. A method for executing applications in a mobile communication terminal, the method comprising the steps of:
accessing a portal server;
receiving a portal package including at least one portal application from the portal server; and
installing the received portal package.

6. The method of claim 5, wherein installing the received portal package comprises:
determining whether there exists a pre-installed portal package; and
deleting the pre-installed portal package and installing the received portal package when the pre-installed portal package exists.

7. A method for executing applications in a mobile communication terminal, the method comprising the steps of:
receiving an input for selecting a menu item linked to an installed portal application or a terminal application compatible with the installed portal application;
accessing a portal server storing contents associated with the installed portal application or the terminal application compatible with the installed portal application;
requesting the accessed portal server to provide the associated contents;
determining whether a login is necessary for a portal service providing the associated contents;
determining whether the terminal has logged into the portal server when the login is necessary; and
receiving and displaying the associated contents using the installed portal application or the terminal application compatible with the installed portal application when the terminal has logged into the portal server.

8. The method of claim 7, further comprising receiving the associated contents when the login is unnecessary.

9. The method of claim 7, further comprising transmitting authentication information to the portal server to log in when the terminal has not logged into the portal server.

10. The method of claim 7, wherein determining whether the login is necessary comprises:
receiving a message informing that a login is necessary for the portal service from the portal server; and
confirming that a login is necessary for the portal service based on the received message.

11. The method of claim 7, wherein determining whether the terminal has logged into the portal server comprises:
receiving a message informing that the terminal has not logged into the portal server from the portal server; and
confirming that the terminal has not logged into the portal server based on the received message.

12. An apparatus for executing applications in a mobile communication terminal, the apparatus comprising:
a wired/wireless communication unit for receiving a portal package including one or more portal applications from a portal server;
a virtual machine driving unit for installing the received portal package and executing the one or more portal applications;
a controller for determining whether there exists a portal application among the one or more portal applications in the portal package compatible with a pre-mounted terminal application and, when a compatible portal application exists, selecting one of the compatible portal application and the pre-mounted terminal application as an application for displaying contents associated with the compatible portal application and the pre-mounted terminal application, the controller linking the selected application to a corresponding menu item and, when the menu item is selected, controlling the virtual machine driving unit so as to drive the selected application linked to the menu item; and
a display unit for displaying the associated contents.

13. The apparatus of claim 12, wherein the controller selects a preset application as an application for displaying the associated contents.

14. The apparatus of claim 12, wherein the controller detects a user input for selecting one of the compatible portal application and the pre-mounted terminal application to determine an application for displaying the associated contents.

15. The apparatus of claim 12, wherein the controller determines whether there exists a pre-installed portal package before the virtual machine driving unit installs the received portal package and controls the virtual machine driving unit to delete the pre-installed portal package when the pre-installed portal package exists.

16. The apparatus of claim 12, wherein the controller is adapted to define the portal application as the application for displaying the associated contents when the compatible terminal application does not exist.

17. A method for executing applications in a mobile communication terminal, the method comprising the steps of:
accessing a plurality of portal servers and receiving a plurality of portal applications included in different portal packages;
installing the received portal applications;
linking the portal applications to corresponding menu items to reconstruct menus; and
displaying associated contents using respective portal applications corresponding to selected menu items linked to the portal applications.
